(19) United States
(12) Patent Application Publication
(10) Pub. No.: US 2025/0187515 A1
(43) Pub. Date: Jun. 12, 2025

(54) HANDLE SYSTEMS FOR MOTOR VEHICLES

(71) Applicant: FORD GLOBAL TECHNOLOGIES, LLC, Dearborn, MI (US)

(72) Inventors: Nathaly Martinez, Hermosillo (MX); Joaquin Hernandez, Aguascalientes (MX); Santiago Bonilla Véliz, Ciudad de Mexico (MX)

(21) Appl. No.: 18/536,649

(22) Filed: Dec. 12, 2023

(51) Int. Cl. B60N 3/02; B62D 25/04

(52) U.S. Cl. CPC B60N 3/02; B62D 25/04

(57) ABSTRACT

A device may include a pillar assembly. A device may include a box rail assembly secured to the pillar assembly. A device may include a handle including a first end portion that interfaces with a rear-facing surface of the pillar assembly and an opposite, second end portion that interfaces with a top surface of the box rail assembly.

### TECHNICAL FIELD

This disclosure relates generally to motor vehicles, and more particularly to multi-purpose handle systems for motor vehicles.

### BACKGROUND

Many motor vehicles include cargo spaces for transporting various types of cargo. A pickup truck, for example, includes a cargo box that establishes the cargo space of the truck. A tailgate is moveable to an open position to provide access at the rear of the cargo box.

### SUMMARY

In some aspects, the techniques described herein relate to a vehicle assembly, including: a pillar assembly; a box rail assembly secured to the pillar assembly; and a handle including a first end portion that interfaces with a rear-facing surface of the pillar assembly and an opposite, second end portion that interfaces with a top surface of the box rail assembly.

In some aspects, the techniques described herein relate to a vehicle assembly, wherein the pillar assembly includes an inner panel, an inner reinforcement panel, an outer panel, and a pillar cover panel.

In some aspects, the techniques described herein relate to a vehicle assembly, wherein the inner panel includes a first side and an opposite, second side, the outer panel includes a first flange and a second flange, and the inner panel is secured on the first side to the inner reinforcement panel and on the second side between the first flange and the second flange.

In some aspects, the techniques described herein relate to a vehicle assembly, wherein the pillar cover panel interfaces with the first flange.

In some aspects, the techniques described herein relate to a vehicle assembly, wherein the pillar cover panel includes a vertically extending portion that provides that provides the rear-facing surface of the pillar assembly and a longitudinally extending portion that provides the top surface of the box rail assembly.

In some aspects, the techniques described herein relate to a vehicle assembly, wherein the first end portion of the handle is received against the vertically extending portion and the second end portion of the handle is received against the longitudinally extending portion.

In some aspects, the techniques described herein relate to a vehicle assembly, wherein the handle includes a handle member and a pair of arms that extend from the handle member at transverse angles.

In some aspects, the techniques described herein relate to a vehicle assembly, wherein the second end portion of the handle extends from one of the arms at a transverse angle.

In some aspects, the techniques described herein relate to a vehicle assembly, wherein a first fastening bolt extends from the first end portion of the handle and a second fastening bolt extends from the second end portion of the handle.

In some aspects, the techniques described herein relate to a vehicle assembly, wherein the first fastening bolt is fastened to the pillar assembly and the second fastening bolt is fastened to a reinforcement bracket on the box rail assembly.

In some aspects, the techniques described herein relate to a vehicle assembly, wherein the pillar assembly includes a first fastening nut for receiving the first fastening bolt and the reinforcement bracket includes a second fastening nut for receiving the second fastening bolt.

In some aspects, the techniques described herein relate to a vehicle assembly, including: a pillar assembly including an inner panel, an inner reinforcement panel, an outer panel, and a pillar cover panel; a box rail assembly secured to the pillar assembly and extending rearward from the pillar assembly; and a handle secured to the pillar assembly and including a first end portion and an opposite, second end portion, the first end portion secured near an interface between the pillar cover panel and the outer panel, the second end portion secured near an interface between the pillar cover panel and the box rail assembly.

In some aspects, the techniques described herein relate to a vehicle assembly, wherein the inner panel includes a first side and an opposite, second side, the outer panel includes a first flange and a second flange, and the inner panel is secured on the first side to the inner reinforcement panel and on the second side between the first flange and the second flange.

In some aspects, the techniques described herein relate to a vehicle assembly, wherein the pillar cover panel interfaces with the first flange.

In some aspects, the techniques described herein relate to a vehicle assembly, wherein the pillar cover panel includes a vertically extending portion that interfaces with the outer panel and a longitudinally extending portion that interfaces with the box rail assembly.

In some aspects, the techniques described herein relate to a vehicle assembly, wherein the first end portion of the handle is received against the vertically extending portion and the second end portion of the handle is received against the longitudinally extending portion.

In some aspects, the techniques described herein relate to a vehicle assembly, wherein a first fastening nut is joined to the inner panel and a second fastening nut is joined to a reinforcement bracket on the box rail assembly, the outer panel and the pillar cover panel each include a first opening that is aligned with the first fastening nut, and the pillar cover panel includes a second opening that is aligned with the second fastening nut.

In some aspects, the techniques described herein relate to a vehicle assembly, a first fastening bolt extends from the first end portion of the handle and a second fastening bolt extends from the second end portion of the handle.

In some aspects, the techniques described herein relate to a vehicle assembly, wherein the first fastening bolt extends through the first opening and fastens to the first fastening nut, and the second fastening bolt extends through the second opening and fastens to the second fastening nut.

In some aspects, the techniques described herein relate to a vehicle assembly, wherein the handle includes a handle member and a pair of arms that extend from the handle member at transverse angles.

### BRIEF DESCRIPTION OF THE DRAWINGS

FIG. 1 schematically illustrates select portions of an exemplary vehicle.

FIG. 2 is a blown-up view of portions of the exemplary vehicle of FIG. 1 and illustrates a handle system of the exemplary vehicle.

FIG. 3 is an exploded view of the handle system of FIG. 2.

FIG. 4 is a cross-sectional view taken along line 4-4 of FIG. 2.

### DETAILED DESCRIPTION

This disclosure details exemplary handle systems for motor vehicles. An exemplary handle system may include a pillar assembly, a box rail assembly, and a handle that facilitates access to a cargo box and provides an anchoring point for securing cargo in the cargo box. These and other features are discussed in greater detail in the following paragraphs of this detailed description.

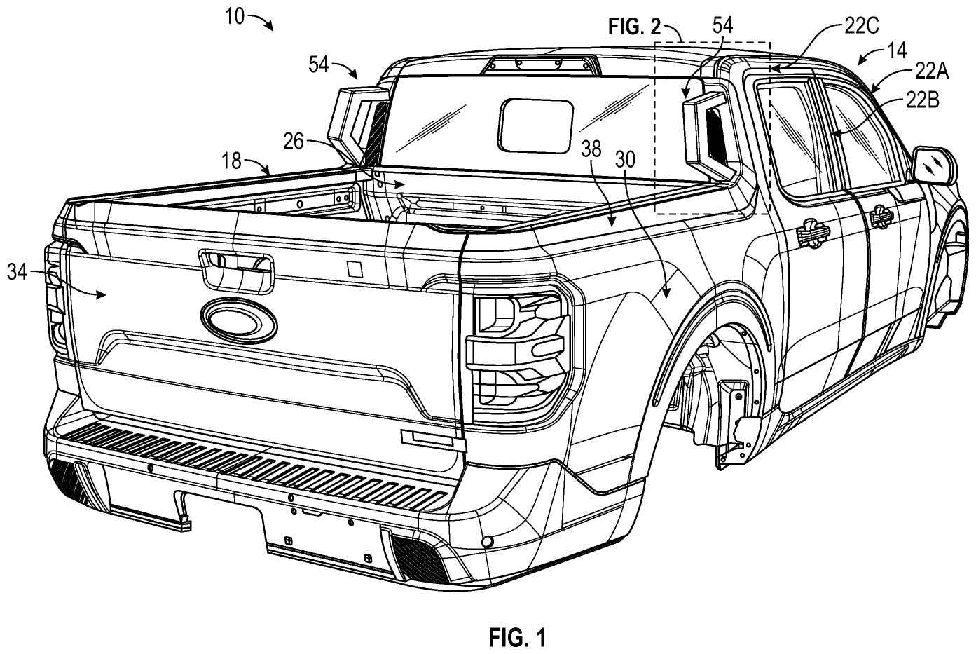

FIGS. 1-3 schematically illustrate select portions of a vehicle 10. In the illustrated embodiment, the vehicle 10 is depicted as a pickup truck. However, the vehicle 10 could alternatively be a car, a van, sports utility vehicle (SUV), or any other vehicle configuration. Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component or system.

The vehicle 10 may include a passenger cabin 14 and a cargo box 18 disposed rearward of the passenger cabin 14. The passenger cabin 14 may define an interior for accommodating one or more vehicle passengers. The passenger cabin 14 may include two or more pillar assemblies 22 located on both a driver side and a passenger side of the vehicle 10. In an embodiment, the vehicle 10 is an extended cab pickup truck and therefore includes first pillar assemblies 22A, which are closest the front of the vehicle 10, third pillar assemblies 22C, which are closest to the cargo box 18 of the vehicle 10, and second pillar assemblies 22B, which are intermediate pillars disposed between the first pillar assemblies 22A and the third pillar assemblies 22C. However, the teachings of this disclosure are also applicable to standard cab pickup trucks, which would only include first and second pillar assemblies.

The cargo box 18 establishes a cargo space for storing and hauling cargo on the vehicle 10. The cargo box 18 may be established by a cab back assembly 26, a pair of opposing and longitudinally extending cargo box panels 30, and a tailgate 34. The cab back assembly 26 extends laterally between the cargo box panels 30 and may separate the passenger cabin 14 from the cargo box 18. The tailgate 34 is located at the rear of the vehicle 10 and may be positioned laterally between the cargo box panels 30. The tailgate 34 may be pivoted relative to the cargo box panels 30 between a closed position and an open position. When in the closed position, the tailgate 34 provides a barrier between the exterior of the vehicle 10 and the cargo box 18. When in the open position, the tailgate 34 permits users to access the cargo box 18.

A pair of opposing and longitudinally extending box rail assemblies 38 may establish upper rails of the cargo box 18. Each box rail assembly 38 may include a first box rail member 42, a second box rail member 46, and a box rail cover panel 50. In an embodiment, the first box rail member 42 intersects the third pillar assembly 22C and extends continuously up to a fourth pillar assembly 22D, which is located at the rear of the vehicle 10, and the second box rail member 46 extends between the fourth pillar assembly 22D and the cab back assembly 26 of the vehicle 10. The first box rail member 42 and the second box rail member 46 may be secured to the cargo box panels 30 (e.g., cargo box inner and outer panels) for constructing the cargo box 18. In an embodiment, the first box rail member 42 and the second box rail member 46 are made of a metallic material.

The box rail cover panel 50 may configured to cover and protect the first box rail member 42 and the second box rail member 46 when cargo is loaded and unloaded in the cargo box 18. In an embodiment, the box rail cover panel 50 extends longitudinally along the cargo box 18 and at least partially covers the fourth pillar 22D, the cargo box panels 30, the first box rail member 42, and the second box rail member 46. The box rail cover panel 50 may be secured (bolted, adhered, etc.) to the first box rail member 42 and the second box rail member 46. In an embodiment, the box rail cover panel 50 is made of a plastic material.

A handle 54 may be provided on each side of the vehicle 10 at an interface between the third pillar assemblies 22C and the box rail assemblies 38. As discussed further below, the handle 54 interfaces with a rear-facing surface of the third pillar assembly 22C and a top surface of the box rail assembly 38.

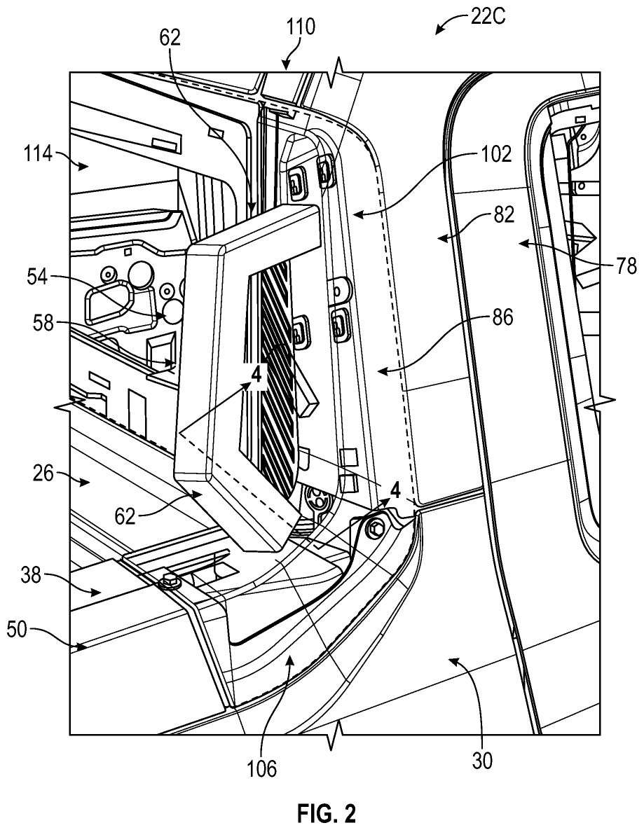

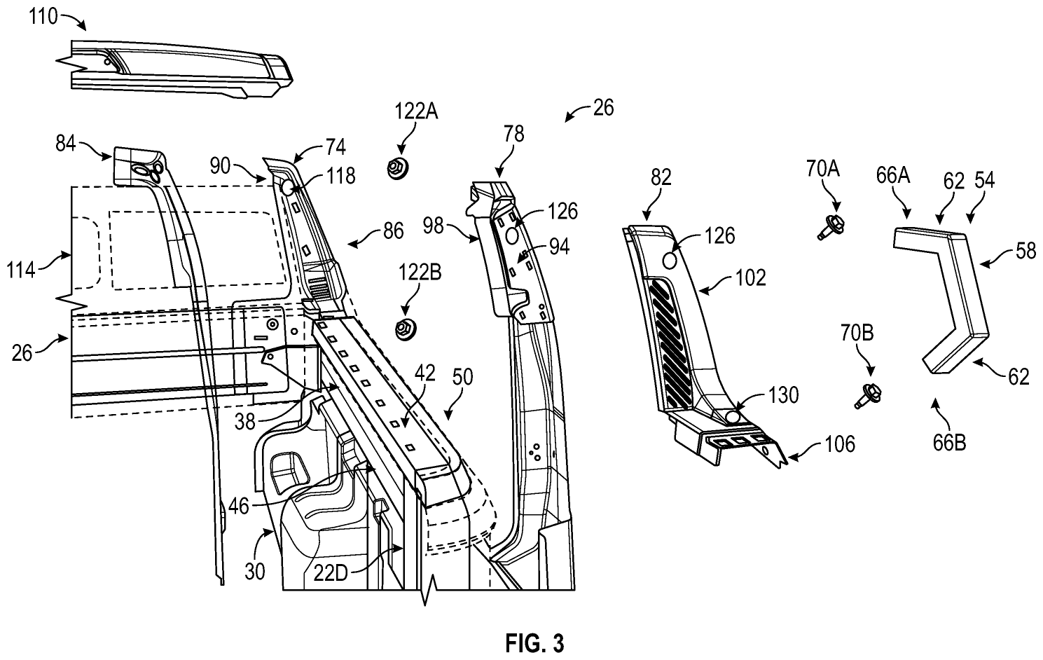

Referring now primarily to FIGS. 2 and 3, the handle 54 may be secured to the third pillar assembly 22C and the box rail assembly 38. In an embodiment, the handle 54 is generally U-shaped and includes a handle member 58 and a pair of arms 62 that extend from the handle member 58, such as at oblique angles, for example. The handle member 58 and the arms 62 may be designed to have any geometry capable of withstanding desired loads. In an embodiment, the handle member 58 and the arms 62 are generally circular in cross-section and have a suitable length and overall diameter that define a handle or bar portion suitable for the intended application. However, other configurations are contemplated within the scope of this disclosure.

The arms 62 of the handle 54 may have a respective first and second end portion 66A/66B from which a respective first and second fastening bolt 70A/70B can extend for securing the handle 54 to the third pillar assembly 22C and the box rail assembly 38. In an embodiment, the second end portion 66B extends from the arms 62 at a transverse angle. In an embodiment, the handle 54 is made of a metallic material.

The third pillar assembly 22C may include an inner panel 74, an outer panel 78, and a pillar cover panel 82. The inner panel 74 may be secured (bolted, welded, etc.) between the outer panel 78 and an inner reinforcement panel 84. The outer panel 78 may be secured (bolted, welded, etc.) between the inner panel 74 and the pillar cover panel 82. In an embodiment, the inner panel 74 is secured on a first side 86 to the inner reinforcement panel 84 and secured on an opposite, second side 90 between a first flange 94 of the outer panel 78 and a second flange 98 of the outer panel 78. In an embodiment, first flange 94 interfaces with the pillar cover panel 82. In an embodiment, the inner panel 74, the outer panel 78, and the inner reinforcement panel 84 are made of a metallic material, and the pillar cover panel 82 is made of a plastic material.

In an embodiment, the pillar cover panel 82 is generally L-shaped and includes a vertically extending portion 102 that interfaces with the outer panel 78 and a longitudinally extending portion 106 that interfaces with the box rail assembly 38. The vertically extending portion 102 may provide a rear-facing surface of the third pillar assembly 22C. The longitudinally extending portion 106 may provide a top surface of the box rail assembly 38. In an embodiment, the vertically extending portion 102 interfaces with the first flange 94 of the outer panel 78, an upper cover assembly 110 of the vehicle 10, and a window assembly 114 of the vehicle 10. In an embodiment, the longitudinally extending portion 106 interfaces with the cab back assembly 26, the cargo box panels 30, and the box rail assembly 38.

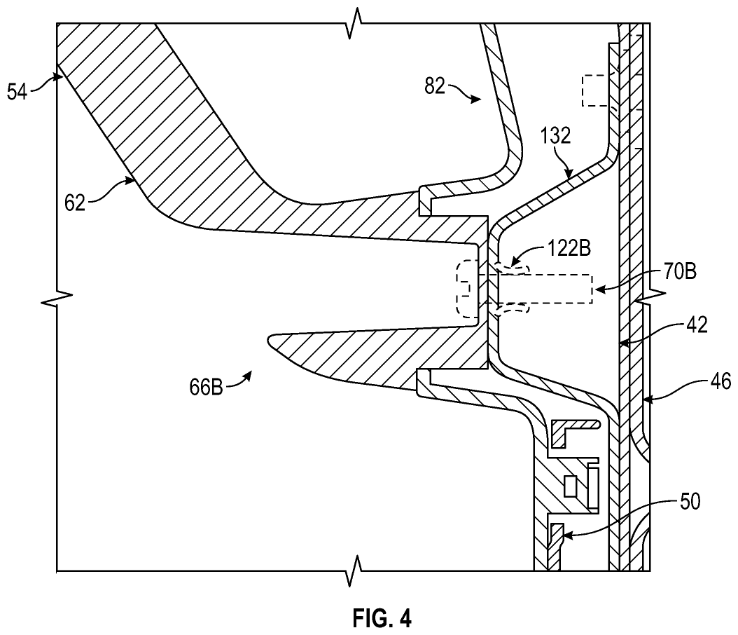

The inner panel 74 of the third pillar assembly 22C may include an aperture 118 for receiving a first fastening nut 122A. The first fastening nut 122A may be joined (e.g., welded, adhered, etc.) to the inner panel 74. The outer panel 78 and the pillar cover panel 82 may each include a first opening 126 which is aligned with an opening of the first fastening nut 122A. A second fastening nut 122B may be joined (e.g., welded, adhered, etc.) to a reinforcement bracket 128 positioned between the first box rail member 42 and the pillar cover panel 82 (see FIG. 4). In an embodiment, the second fastening nut 122B is joined to the reinforcement bracket 128, and the pillar cover panel 82 includes a second opening 130 which is aligned with an opening of the second fastening nut 122B. The reinforcement bracket 128 may be secured (e.g., bolted, welded, etc.) to the first box rail member 42 and the second box rail member 46. In an embodiment, the reinforcement bracket 128 is made of a metallic material. In an embodiment, the first fastening nut 122A can be configured to mirror that of the second fastening nut 122B. For example, the first fastening nut 122A may be joined to a reinforcement bracket on the inner panel 74 or the outer panel 78.

The first and second fastening nuts 122A/122B may be used to secure the handle 54 to the vehicle 10. In an embodiment, the first fastening bolt 70A of the handle 54 extends through the first opening 126 of the outer panel 78 and the pillar cover panel 82 and fastens to the first fastening nut 122A, and the second fastening bolt 70B of the handle 54 extends through the second opening 130 of the pillar cover panel 82 and fastens to the second fastening nut 122B. As a result, the first end portion 66A of the handle 54 is received against the vertically extending portion 102 of the pillar cover panel 82 and thus interfaces with the third pillar assembly 22C, and the second end portion 66B of the handle 54 is received against the longitudinally extending portion 106 of the pillar cover panel 82 and thus interfaces with the box rail assembly 38.

Together, the fourth pillar assembly 22, the box rail assembly 38, and the handle 54 form a handle system 134 for facilitating access to the cargo box 18 and providing one or more anchoring points for securing cargo in the cargo box 18. For example, the handle 54 can serve as a grab handle for assisting a user when accessing (i.e., ascending and descending) the cargo box 18, and the handle 54 can also serve as a cargo bar for securing cargo on the vehicle 10. For example, a user may tie one or more ropes, cables, and/or straps around the handle 54 and the cargo on the vehicle 10 to secure cargo and prevent it from shifting during transportation. Accordingly, the handle 54 of the handle system 134 may be a multi-purpose handle.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A vehicle assembly, comprising:
a pillar assembly;
a box rail assembly secured to the pillar assembly; and
a handle including a first end portion that interfaces with a rear-facing surface of the pillar assembly and an opposite, second end portion that interfaces with a top surface of the box rail assembly.

2. The vehicle assembly as recited in claim 1, wherein the pillar assembly includes an inner panel, an inner reinforcement panel, an outer panel, and a pillar cover panel.

3. The vehicle assembly as recited in claim 2, wherein the inner panel includes a first side and an opposite, second side, the outer panel includes a first flange and a second flange, and the inner panel is secured on the first side to the inner reinforcement panel and on the second side between the first flange and the second flange.

4. The vehicle assembly as recited in claim 3, wherein the pillar cover panel interfaces with the first flange.

5. The vehicle assembly as recited in claim 2, wherein the pillar cover panel includes a vertically extending portion that provides that provides the rear-facing surface of the pillar assembly and a longitudinally extending portion that provides the top surface of the box rail assembly.

6. The vehicle assembly as recited in claim 5, wherein the first end portion of the handle is received against the vertically extending portion and the second end portion of the handle is received against the longitudinally extending portion.

7. The vehicle assembly as recited in claim 1, wherein the handle includes a handle member and a pair of arms that extend from the handle member at transverse angles.

8. The vehicle assembly as recited in claim 7, wherein the second end portion of the handle extends from one of the arms at a transverse angle.

9. The vehicle assembly as recited in claim 1, wherein a first fastening bolt extends from the first end portion of the handle and a second fastening bolt extends from the second end portion of the handle.

10. The vehicle assembly as recited in claim 9, wherein the first fastening bolt is fastened to the pillar assembly and the second fastening bolt is fastened to a reinforcement bracket on the box rail assembly.

11. The vehicle assembly as recited in claim 9, wherein the pillar assembly includes a first fastening nut for receiving the first fastening bolt and the reinforcement bracket includes a second fastening nut for receiving the second fastening bolt.

12. A vehicle assembly, comprising:
a pillar assembly including an inner panel, an inner reinforcement panel, an outer panel, and a pillar cover panel;
a box rail assembly secured to the pillar assembly and extending rearward from the pillar assembly; and
a handle secured to the pillar assembly and including a first end portion and an opposite, second end portion, the first end portion secured near an interface between the pillar cover panel and the outer panel, the second end portion secured near an interface between the pillar cover panel and the box rail assembly.

13. The vehicle assembly as recited in claim 12, wherein the inner panel includes a first side and an opposite, second side, the outer panel includes a first flange and a second flange, and the inner panel is secured on the first side to the inner reinforcement panel and on the second side between the first flange and the second flange.

14. The vehicle assembly as recited in claim 13, wherein the pillar cover panel interfaces with the first flange.

15. The vehicle assembly as recited in claim 12, wherein the pillar cover panel includes a vertically extending portion that interfaces with the outer panel and a longitudinally extending portion that interfaces with the box rail assembly.

16. The vehicle assembly as recited in claim 15, wherein the first end portion of the handle is received against the vertically extending portion and the second end portion of the handle is received against the longitudinally extending portion.

17. The vehicle assembly as recited in claim 12, wherein a first fastening nut is joined to the inner panel and a second fastening nut is joined to a reinforcement bracket on the box rail assembly, the outer panel and the pillar cover panel each include a first opening that is aligned with the first fastening nut, and the pillar cover panel includes a second opening that is aligned with the second fastening nut.

18. The vehicle assembly as recited in claim 17, a first fastening bolt extends from the first end portion of the handle and a second fastening bolt extends from the second end portion of the handle.

19. The vehicle assembly as recited in claim 18, wherein the first fastening bolt extends through the first opening and fastens to the first fastening nut, and the second fastening bolt extends through the second opening and fastens to the second fastening nut.

20. The vehicle assembly as recited in claim 12, wherein the handle includes a handle member and a pair of arms that extend from the handle member at transverse angles.
